(19) United States
(12) Patent Application Publication
(10) Pub. No.: US 2026/0235142 A1
(43) Pub. Date: Aug. 13, 2026

(54) LOAD DAMPENING SYSTEM

(71) Applicant: J.C. Bamford Excavators Limited, Uttoxeter (GB)

(72) Inventors: James Hewitt, Uttoxeter (GB); Seb Parkes, Uttoxeter (GB)

(21) Appl. No.: 19/394,318

(22) Filed: Nov. 19, 2025

(30) Foreign Application Priority Data
Nov. 20, 2024 (GB) 2417099.5

(51) Int. Cl. F15B 1/02; B66F 9/22; E02F 9/22

(52) U.S. Cl. CPC F15B 1/021; B66F 9/22; E02F 9/2207; E02F 9/2217; F15B 2211/625; F15B 2211/6313; F15B 2211/8613

(57) ABSTRACT

A load dampening system for a working vehicle is provided. The load dampening system includes a load handling hydraulic actuator configured to support a load carried by the working vehicle and an accumulator apparatus for storing pressurized hydraulic fluid. The accumulator apparatus is selectively connectable to the load handling hydraulic actuator to act as a compliant element which dampens pressure fluctuations in the load handing hydraulic actuator. The load dampening system also includes a control system configured to adjust a compliance of the accumulator apparatus to adjust the extent to which the accumulator apparatus dampens pressure fluctuations in the load handling hydraulic actuator.

### FIELD

The present disclosure relates to a load dampening system. Aspects of the invention relate to a load dampening system, a working vehicle, an adjustable compressed fluid accumulator, and a method.

### BACKGROUND

There are various types of working vehicles which may be used to transport a payload using a load handling implement, such as a shovel or forks coupled to a working arm. For example, known types of working vehicles include materials handling vehicles such as telescopic handlers, wheel loading shovels, and backhoe loaders, amongst others.

In such a working vehicle, a load dampening system may be provided to absorb shocks and reduce oscillations of the load handling implement, for example, during movement over uneven terrain. This may reduce load loss and damage, as well as improving the driving feel of the working vehicle.

It is an aim of the present invention to address one or more of the disadvantages associated with the prior art.

### SUMMARY

The present teachings provide a load dampening system, a working vehicle, an adjustable compressed fluid accumulator, and a method according to the appended claims.

An aspect of the teachings provides a load dampening system for a working vehicle. The load dampening system may comprise a load handling hydraulic actuator configured to support a load carried by the working vehicle. For example, the load handling hydraulic actuator may be configured to move a load handling apparatus of the working vehicle and to support a load carried by the load handling apparatus. The load dampening system may comprise an accumulator apparatus for storing pressurized hydraulic fluid. The accumulator apparatus may be selectively connectable to the load handling hydraulic actuator to act as a compliant element which dampens pressure fluctuations in the load handing hydraulic actuator. The load dampening system may comprise a control system configured to adjust a compliance of the accumulator apparatus to adjust the extent to which the accumulator apparatus dampens pressure fluctuations in the load handling hydraulic actuator.

By having a control system configured to adjust the compliance of the accumulator apparatus, the performance of the accumulator apparatus can be adjusted to account for different payload masses, as well as velocity and acceleration of the working vehicle and/or payload caused by travelling and/or steering of the working vehicle. This contrasts with a traditional load dampening system which has an accumulator apparatus with a fixed compliance value that can therefore only be optimized for a particular operating condition and/or payload.

Optionally, the control system is configured for continuously variable adjustment of the compliance of the accumulator apparatus.

For example, the control system may be configured to adjust the compliance of the accumulator apparatus to any desired value between a maximum value and a minimum value, as opposed to alternative configurations in which the accumulator apparatus can only be switched between discrete compliance levels. This allows the load dampening system to be tuned for a wider range of payloads and operating conditions of the working vehicle.

Optionally, the accumulator apparatus comprises a continuously variable control member. Optionally, the control system is configured to move the continuously variable control member to adjust the compliance of the accumulator apparatus.

For example, the continuously variable control member may comprise a piston, a flexible diaphragm, a proportional valve, or any other suitable control member.

Optionally, the control system comprises a load sensor configured to measure a mass of a payload carried by the working vehicle. Optionally, the control system is configured to adjust the compliance of the accumulator apparatus based on the measured payload mass.

For example, the control system may automatically tune the performance of the load dampening system to account for changes in the payload mass.

Optionally, the load sensor comprises a pressure sensor or transducer coupled to the load handling hydraulic actuator.

Optionally, the control system is configured to reduce compliance of the accumulator apparatus as the payload mass increases.

In other words, the control system may be configured to increase stiffness of the accumulator apparatus as the payload mass increases. Similarly, the control system may be configured to increase compliance of the accumulator apparatus (i.e., decrease stiffness) as the payload mass decreases. For example, the control system may use an inverse relationship between payload mass and desired compliance. This avoids excessive movement of the load handling apparatus of the working vehicle under heavier payloads, whilst still facilitating suitable dampening for lighter payloads or unloaded operating conditions.

Optionally, the control system comprises a controller configured to receive a payload mass signal from the load sensor and output a control signal to a compliance actuator for adjusting the compliance of the accumulator apparatus.

Such a configuration facilitates automated adjustment of the load dampening system.

Optionally, the control system comprises a compliance sensor configured to measure a quantity indicative of the compliance of the accumulator apparatus. Optionally, the controller is configured to receive a compliance signal from the compliance sensor and to use feedback control to vary the control signal.

Such a configuration facilitates accurate control of the compliant behavior of the load dampening system.

Optionally, the accumulator apparatus comprises a compressed fluid accumulator having a compressed fluid chamber and a hydraulic fluid chamber which is selectively connectable to the load handling hydraulic actuator. Optionally, the control system is configured to adjust a pressure in the compressed fluid chamber to adjust the compliance of the accumulator apparatus.

For example, when a stiffer response is required, pressure in the compressed fluid chamber may be increased. Similarly, when a more compliant response is required, pressure in the compressed fluid chamber may be decreased.

Compressed fluid accumulators are known for use in load dampening systems of working vehicles. Therefore, providing the adjustable accumulator apparatus in the form of an adjustable compressed fluid accumulator facilitates compatibility with other components of the load dampening system.

Optionally, the compressed fluid accumulator comprises a first adjustable barrier at a first end of the compressed fluid chamber, the first adjustable barrier separating the compressed fluid chamber and the hydraulic fluid chamber. Optionally, the compressed fluid accumulator further comprises a second adjustable barrier at a second end of the compressed fluid chamber. Optionally, the control system is configured to adjust the second adjustable barrier in order to adjust the pressure in the compressed fluid chamber.

Such a configuration provides a simple means of adjusting the pressure within the compressed fluid chamber, in order to adjust the compliance of the accumulator apparatus.

Optionally, the first and/or second adjustable barrier comprises a piston.

For example, adjustment of the first and/or second adjustable barrier may comprise movement of the piston (e.g., sliding within a cylinder). A piston provides a simple adjustable barrier that can easily be acted on by external forces (e.g., pressurized fluids, linear actuators, etc.).

Alternatively, the first and/or second adjustable barrier may comprise a flexible diaphragm. For example, adjustment of the first and/or second adjustable barrier may comprise flexing of the diaphragm.

Optionally, the compressed fluid accumulator comprises a single cylinder. Optionally, the hydraulic fluid chamber, compressed fluid chamber and first and second adjustable barriers are provided within the single cylinder.

This provides a compact accumulator apparatus.

Optionally, the compressed fluid accumulator comprises a first cylinder and a second cylinder. Optionally, the hydraulic fluid chamber, first adjustable barrier and a first portion of the compressed fluid chamber are provided within the first cylinder. Optionally, a second portion of the compressed fluid chamber and the second adjustable barrier are provided within the second cylinder. Optionally, the first and second portions of the compressed fluid chamber are connected to each other by a compressed fluid line between the first and second cylinders.

Such a compressed fluid accumulator may be constructed from off-the-shelf components (e.g., two standard compressed fluid accumulators joined by the compressed fluid line). This may simplify manufacturing and reduce costs in comparison to an integrated single cylinder arrangement.

Further, such a compressed fluid accumulator may facilitate more flexible packaging (e.g., with first and second cylinders being coaxially aligned, parallel, at an angle to each other, one above the other, side-by-side, etc.).

Optionally, the control system is configured to apply pressurized hydraulic fluid to the second adjustable barrier in order to adjust the second adjustable barrier and thereby adjust the pressure in the compressed fluid chamber.

In other words, the second adjustable barrier may be hydraulically-actuated. This may facilitate use of existing hydraulic components (e.g., a hydraulic pump) of the working vehicle.

Optionally, the compressed fluid accumulator comprises an adjustment chamber. Optionally, the second adjustable barrier separates the compressed fluid chamber from the adjustment chamber. Optionally, the control system comprises a hydraulic pump connected to the adjustment chamber by a hydraulic line in order to apply pressurized hydraulic fluid to the second adjustable barrier.

Such a configuration provides a simple means for hydraulically actuating the second adjustable barrier.

Optionally, the control system comprises an adjustable valve configured to vary pressure in the hydraulic line.

Such an adjustable valve provides a simple means of controlling actuation of the second adjustable barrier. In addition, such a valve may allow pressure in the adjustment chamber to be controlled independently of the output of the hydraulic pump, which may be beneficial when the hydraulic pump is used for supplying hydraulic fluid to other systems of the working vehicle.

Optionally, the adjustable valve is an electronic valve, optionally a solenoid-operated valve.

Such an adjustable valve can be controlled simply by the control system (e.g., by sending a control signal from a controller to the electronic valve, e.g., to a solenoid of the electronic valve).

Optionally, the adjustable valve comprises a variable pressure relief valve connected to the hydraulic line via a branch line, optionally a proportional pressure relief valve.

Such a variable pressure relief valve provides a simple means of adjusting pressure in the hydraulic line.

Optionally, the adjustable valve comprises a pressure reducing valve provided in the hydraulic line.

Such a pressure reducing valve provides a simple means of adjusting pressure in the hydraulic line.

In some embodiments the adjustable valve may comprise both a variable pressure relief valve and a pressure reducing valve.

Optionally, the control system is configured to adjust an output from the hydraulic pump in order to adjust pressure in the hydraulic line.

For example, the hydraulic pump may be a variable displacement pump or a fixed displacement pump driven by a variable actuator (e.g., an electric motor). The control system may increase output from the hydraulic pump in order to increase pressure in the hydraulic line, and decrease output from the hydraulic pump in order to decrease pressure in the hydraulic line.

The control system may adjust output from the hydraulic pump instead of, or in addition to, actuating an adjustable valve to control pressure in the hydraulic line.

Optionally, the control system comprises a pressure sensor or transducer configured to measure pressure in the adjustment chamber, and a controller configured to receive a pressure signal from the pressure sensor or transducer and to use feedback control to adjust the pressure in the adjustment chamber based on the pressure signal.

For example, the controller may use feedback control to set one or more control signals to control an adjustable valve and/or hydraulic pump to adjust the pressure in the adjustment chamber. This may facilitate accurate control of the compliant behavior of the load dampening system.

Optionally, the second adjustable barrier comprises a piston. Optionally, the control system comprises an adjustment actuator which is mechanically coupled to the piston for moving the piston.

Such an adjustment actuator provides a simple means for setting a position of the piston. This allows pre-load on the compressed fluid accumulator to be adjusted via movement of the piston.

Optionally, the adjustment actuator comprises a linear actuator; optionally, an electric linear actuator.

Such a linear actuator (e.g., electric linear actuator) provides a simple means of moving the piston.

Optionally, the compressed fluid accumulator comprises a charging port in fluid communication with the compressed fluid chamber, for input of compressible fluid to the compressed fluid chamber.

Such a charging fluid port facilitates charging and/or discharging of the compressed fluid chamber.

Optionally, the accumulator apparatus comprises an accumulator having a hydraulic fluid chamber in selective fluid communication with the load handling actuator, and an accumulator control valve provided between the hydraulic fluid chamber and the load handling hydraulic actuator. Optionally, the control system is configured to vary a flow area of a restriction of the accumulator control valve to adjust the compliance of the accumulator apparatus.

In such a configuration, the compliance in the accumulator apparatus may be provided by a pressure drop across the variable restriction of the accumulator control valve, rather than a direct reaction force. For example, when the flow area of the restriction is reduced, pressure drop across the variable orifice increases, which reduces compliance.

Optionally, the accumulator control valve is a proportional control valve.

For example, the flow area of the restriction of the accumulator control valve may be adjusted to any desired value between a maximum flow area (e.g., fully open) and a minimum flow area (e.g., fully closed), as opposed to alternative configurations in which the accumulator control valve can only be switched between discrete states. This allows the load dampening system to be tuned for a wider range of payloads and operating conditions of the working vehicle.

Optionally, the accumulator control valve is an electronic valve, optionally a solenoid-operated valve.

Such an accumulator control valve can be controlled simply by the control system (e.g., by sending a control signal from a controller to the electronic valve, e.g., to a solenoid of the electronic valve).

Optionally, the accumulator control valve is a pilot-operated valve having a pilot port. Optionally, the control system comprises a hydraulic pump connected to the pilot port by a pilot line in order to apply pressurized hydraulic fluid to the pilot port to adjust the restriction of the accumulator control valve.

This may facilitate use of existing hydraulic components (e.g., a hydraulic pump) of the working vehicle.

Optionally, the control system comprises an adjustable valve configured to vary pressure in the pilot line.

Such an adjustable valve provides a simple means of controlling actuation of the accumulator control valve. In addition, such a valve may allow pressure at the pilot port to be controlled independently of the output of the hydraulic pump, which may be beneficial when the hydraulic pump is used for supplying hydraulic fluid to other systems of the working vehicle.

Optionally, the adjustable valve is an electronic valve, optionally a solenoid-operated valve.

Such an adjustable valve can be controlled simply by the control system (e.g., by sending a control signal from a controller to the electronic valve, e.g., to a solenoid of the electronic valve).

Optionally, the adjustable valve comprises a variable pressure relief valve connected to the pilot line via a branch line, optionally a proportional pressure relief valve.

Such a variable pressure relief valve provides a simple means of adjusting pressure at the pilot port.

Optionally, the adjustable valve comprises a pressure reducing valve provided in the pilot line.

Such a pressure reducing valve provides a simple means of adjusting pressure at the pilot port.

In some embodiments the adjustable valve may comprise both a variable pressure relief valve and a pressure reducing valve.

Optionally, the control system is configured to adjust output from the hydraulic pump in order to adjust pressure in the pilot line.

For example, the hydraulic pump may be a variable displacement pump or a fixed displacement pump driven by a variable actuator (e.g., an electric motor). The control system may increase output from the hydraulic pump in order to increase pressure at the pilot port, and decrease output from the hydraulic pump in order to decrease pressure at the pilot port.

The control system may adjust output from the hydraulic pump instead of, or in addition to, actuating an adjustable valve to control pressure in the pilot line.

Optionally, the control system comprises a pressure sensor or transducer configured to measure pressure in the pilot line. Optionally, the control system comprises a controller configured to receive a pressure signal from the pressure sensor or transducer and to use feedback control to adjust the pressure in the pilot line based on the pressure signal.

For example, the controller may use feedback control to set one or more control signals to control an adjustable valve and/or hydraulic pump to adjust the pressure in the pilot line. This may facilitate accurate control of the compliant behavior of the load dampening system.

Optionally, the control system comprises first and second pressure sensors or transducers configured to measure pressure drop across the restriction of the accumulator control valve, and a controller configured to receive first and second pressure signals from the first and second pressure sensors or transducers and to use feedback control to adjust the flow area of the restriction of the accumulator control valve based on the first and second pressure signals.

This may facilitate accurate control of the compliant behavior of the load dampening system.

Optionally, the control system comprises a temperature sensor configured to measure a temperature of hydraulic fluid in the load handling actuator, the hydraulic fluid chamber and/or a hydraulic line therebetween. Optionally, the control system comprises a controller configured to receive a temperature signal from the temperature sensor and to adjust the compliance of the accumulator apparatus based on the temperature signal.

Such a configuration may facilitate tuning of the accumulator apparatus to account for variations in viscosity of the hydraulic fluid.

Optionally, the controller is configured to receive a temperature signal from the temperature sensor and to adjust the restriction of the accumulator control valve based on the temperature signal.

Optionally, the controller comprises a memory having a stored temperature-to-viscosity relationship for the hydraulic fluid, wherein the controller is configured to use the stored temperature-to-viscosity relationship and the temperature signal to determine a viscosity of the hydraulic fluid. Optionally, the controller is further configured to adjust the compliance of the accumulator apparatus based on the determined viscosity. Optionally, the controller is configured to adjust the restriction of the accumulator control valve based on the determined viscosity.

Optionally, the accumulator apparatus comprises a hydraulic cylinder having a hydraulic fluid chamber in selective fluid communication with the load handling actuator, and an adjustable barrier for varying the volume of the hydraulic fluid chamber. Optionally, the control system is configured to use feedback control to directly adjust the adjustable barrier in response to changes in pressure in the hydraulic fluid chamber.

In other words, instead of a compressed fluid (e.g., gas) being used to act as a compliant spring element, the control system may use feedback control to move the adjustable barrier to mimic the behavior of a spring element. Put another way, the control system may directly move the adjustable barrier (e.g., piston) so that it behaves in a similar manner to the way in which a corresponding adjustable barrier (e.g., piston) would be urged by a spring element (e.g., in a compressed fluid accumulator configuration).

Such a direct control of the adjustable barrier may facilitate a more flexible range of control options (e.g., more flexible choice of movement of the adjustable barrier). Further, such a direct control of the adjustable barrier may remove the need for maintenance stages such as charging/discharging a compressed fluid accumulator.

Optionally, the adjustable barrier comprises a piston. Optionally, the control system comprises an electric actuator configured to move the piston.

Optionally, the hydraulic cylinder comprises an adjustment chamber separated from the hydraulic fluid chamber by the piston, and the control system is configured to supply pressurized fluid to the adjustment chamber to move the piston.

Optionally, the accumulator apparatus comprises first and second accumulator apparatuses which are each selectively connectable to the load handling hydraulic actuator to act as a compliant element which dampens pressure fluctuations in the load handing hydraulic actuator. Optionally, the control system is configured to adjust the compliance of the first accumulator apparatus between a first range of compliance values, and to adjust the compliance of the second accumulator apparatus between a second range of compliance values, different to the first range of compliance values.

This facilitates a wider range of compliance values than may be possible with a single accumulator apparatus. For example, where the first and second accumulator apparatuses are compressed fluid accumulators, the first compressed fluid accumulator may be pre-charged to a higher pressure than the second compressed fluid accumulator. The control system may then select the most suitable of the accumulator apparatuses to use for a given payload or operating condition (e.g., the first compressed fluid accumulator for laden conditions and the second compressed fluid accumulator for unladen conditions), and subsequently tune the compliance of the selected accumulator apparatus based on other factors such as payload mass, and velocity/acceleration of the payload and/or working vehicle.

A further aspect of the teachings provides a working vehicle comprising a load dampening system as disclosed herein, and a load handling apparatus configured to be moved by the load handling hydraulic actuator.

Such a working vehicle benefits from the advantages of the load dampening systems outlined above.

Optionally, the working vehicle comprises a hydraulic pump connected to the load handling hydraulic actuator by a hydraulic circuit, for actuating the load handling apparatus.

Optionally, the working vehicle comprises a telescopic handler, a wheel loading shovel, a backhoe loader, or another type of vehicle having a loader arm.

Such working vehicles may be used for transporting a wide variety of payload, and in a wide variety of operating conditions. Therefore, the load dampening systems outlined above may be particularly beneficial for these types of working vehicles.

A further aspect of the teachings provides an adjustable compressed fluid accumulator comprising: a compressed fluid chamber; a hydraulic fluid chamber for coupling to a load-bearing hydraulic circuit; and a first adjustable barrier at a first end of the compressed fluid chamber, the first adjustable barrier separating the compressed fluid chamber and the hydraulic fluid chamber. The adjustable compressed fluid accumulator may comprise a second adjustable barrier at a second end of the compressed fluid chamber, the second adjustable barrier being configured to be acted upon by an external force to adjust the pressure in the compressed fluid chamber.

Such a configuration provides a simple means of providing an accumulator apparatus with an adjustable compliance. For example, a pressurized hydraulic fluid may act on the second adjustable barrier to balance hydraulic fluid in the load-bearing hydraulic circuit. Alternatively, an actuator such as an electric linear actuator may be used to move the second adjustable barrier to adjust a preload of the compressed fluid chamber.

A further aspect of the teachings provides a method of adjusting compliance in an accumulator apparatus, the method comprising: a) determining a payload mass supported by a load handling actuator of a working vehicle; b) using the determined payload mass to determine a desired compliance of an accumulator apparatus which is connected to the load handling actuator; and c) controlling a compliance actuator in order to adjust the compliance of the accumulator apparatus 100 as desired.

Such a method allows the performance of the accumulator apparatus to be adjusted to account for different payload masses.

Optionally, step a) comprises receiving a payload mass signal from a load sensor, the payload mass signal being indicative of a payload supported by a load handling actuator.

Optionally, step c) comprises determining a control signal required to achieve the desired compliance of the accumulator apparatus, and outputting the determined control signal to the compliance actuator.

Optionally, the method comprises receiving a compliance signal indicative of the compliance of the accumulator apparatus from a compliance sensor, and using the compliance signal at step c) to determine how to control the compliance actuator (e.g., using feedback control).

Optionally, step b) comprises reducing the desired compliance as the determined payload mass increases.

It will be appreciated that any feature of any of the aspects of the teachings outlined above may be combined with any compatible features of any of the other aspects of the teachings above. For the sake of brevity, not all combinations are explicitly recited above.

### BRIEF DESCRIPTION OF DRAWINGS

Embodiments will now be described by way of example only with reference to the accompanying figures, in which:

FIG. 1 is a side view of a working vehicle according to an embodiment;

FIG. 2 is a side view of a working vehicle according to a further embodiment;

FIG. 3 is a schematic diagram of a load dampening system for the working vehicle of FIG. 1 or FIG. 2, according to an embodiment;

FIG. 4 shows an accumulator apparatus and control system for use in the load dampening system of FIG. 3;

FIG. 5 shows a further accumulator apparatus and control system for use in the load dampening system of FIG. 3;

FIG. 6 shows a further accumulator apparatus and control system for use in the load dampening system of FIG. 3;

FIG. 7 shows a further accumulator apparatus and control system for use in the load dampening system of FIG. 3;

FIG. 8 shows a further accumulator apparatus and control system for use in the load dampening system of FIG. 3; and

FIG. 9 is a flow chart of a method of adjusting compliance in an accumulator apparatus, according to an embodiment.

### DETAILED DESCRIPTION

In the following detailed description, numerous specific details are set forth in order to provide a thorough understanding of various embodiments and the teachings. However, those skilled in the art will understand that: the present teachings may be practiced without these specific details or with known equivalents of these specific details; that the present teachings are not limited to the described embodiments; and, that the present teachings may be practiced in a variety of alternative embodiments. It will also be appreciated that well known methods, procedures, components, and systems may not have been described in detail.

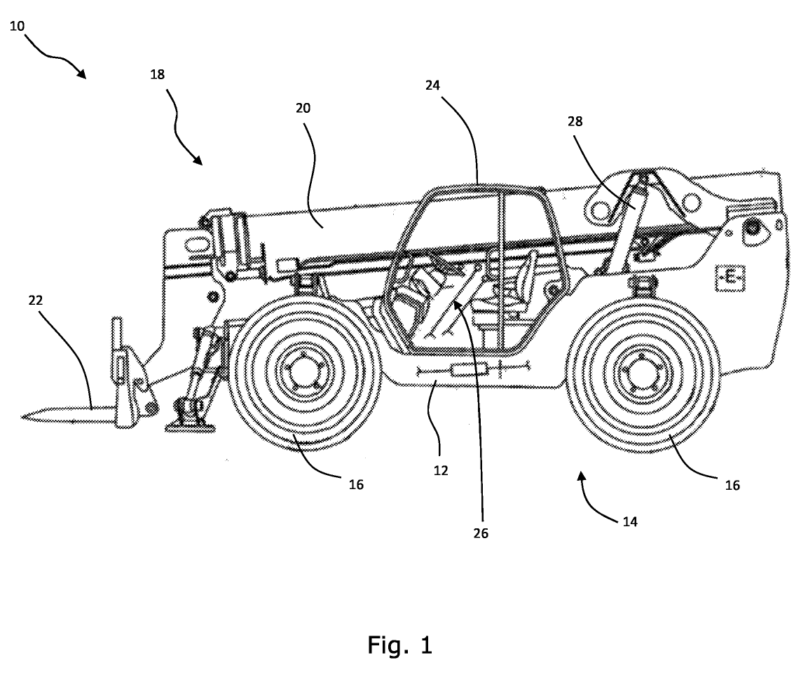

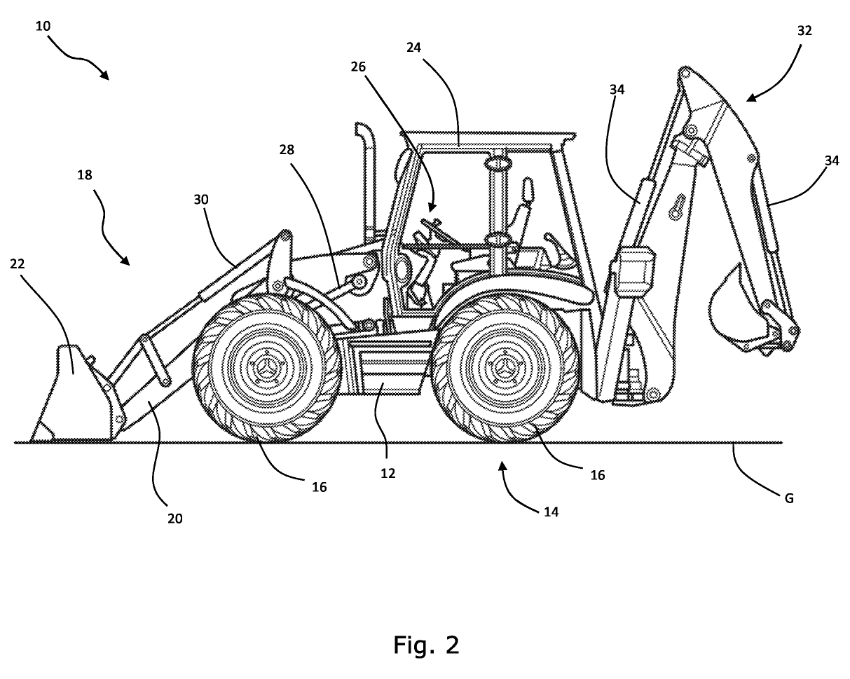

FIGS. 1 and 2 show working vehicles 10, which are examples of types of vehicles to which the claimed invention may be applied.

A working vehicle is an off-highway vehicle, for example those used in construction industries (e.g., backhoe loaders, excavators, slew excavators, telescopic handlers, forklifts, skid-steer loaders, dump trucks, bulldozers, graders), agricultural industries (e.g., tractors, combine harvesters, self-propelled harvesters, and sprayers), quarrying (e.g., loading shovels, dump trucks), and forestry (e.g., timber harvesters, feller bunchers).

In the embodiment of FIG. 1, the working vehicle 10 is a telescopic handler. In the embodiment of FIG. 2, the working vehicle 10 is a backhoe loader. However, it shall be appreciated that in other embodiments, the claimed invention may be applied to other forms of vehicle.

The working vehicles 10 depicted in FIGS. 1 and 2 each have a chassis 12, and a ground engaging propulsion structure 14 for moving the working vehicle 10 over a ground surface G. In particular, the ground engaging propulsion structure 14 includes four wheels 16 coupled to the chassis 12 for moving the chassis 12 over the ground surface G.

The working vehicles 10 of FIGS. 1 and 2 also have a load handling apparatus 18. The load handling apparatus 18 includes a working arm 20 which is pivotally attached to the chassis 12, and an implement 22 which is attached to an end of the working arm 20.

In the embodiment of FIG. 1, the implement 22 is a fork. In the embodiment of FIG. 2, the implement 22 is a shovel. In other embodiments, the implement 22 may be a bucket, or other type of implement (e.g., pallet fork, silage or manure fork, bale grab, lifting jib, etc.). In use, the load handling apparatus 18 may be used to lift and transport a payload received on or in the implement 22 (e.g., palletized goods, loose building material such as aggregates, agricultural products such as manure or silage, etc.).

The working vehicles 10 of FIGS. 1 and 2 also have a prime mover (not shown) mounted to the chassis 12. The prime mover may include one or more internal combustion engines, battery-powered electric motors, or any other suitable type of prime mover. The prime mover may be used to drive the ground engaging propulsion structure 14 and/or the load handling apparatus 18.

In the embodiments of FIGS. 1 and 2, a cab 24 is further mounted to chassis 12. The cab 24 is provided with a collection of controls 26 for moving the load handling apparatus 18, maneuvering the working vehicle 10 and/or controlling other functions of the working vehicle 10.

In the embodiments of FIGS. 1 and 2, the load handling apparatus 18 is configured to be moved by a load handling hydraulic actuator 28. In particular, the load handling hydraulic actuator 28 is a lifting cylinder configured to pivot the working arm 20 of the load handling apparatus 18 upwards and downwards relative to the chassis 12. When the load handling hydraulic actuator 28 is at least partially extended, this causes the implement 22 of the load handling apparatus 18 to be raised off the ground (e.g., for transporting a payload carried by the implement 22 to another location). It will be understood that, in such a condition, the load handling hydraulic actuator 28 will support a load carried by the working vehicle 10 (i.e., carried by the implement 22).

In the embodiment of FIG. 2, the implement 22 is pivotable relative to the working arm 20 by an implement actuator 30. Although not illustrated, a similar implement actuator 30 may be provided in the embodiment of FIG. 1.

In the embodiment of FIG. 1, the working arm 20 is a telescopic working arm. A telescoping actuator (not shown) may be provided to extend and retract the telescopic working arm 20.

In the embodiment of FIG. 2, the working vehicle 10 also includes a backhoe 32, which may be used for excavating operations. The backhoe 32 is actuatable via a plurality of backhoe actuators 34.

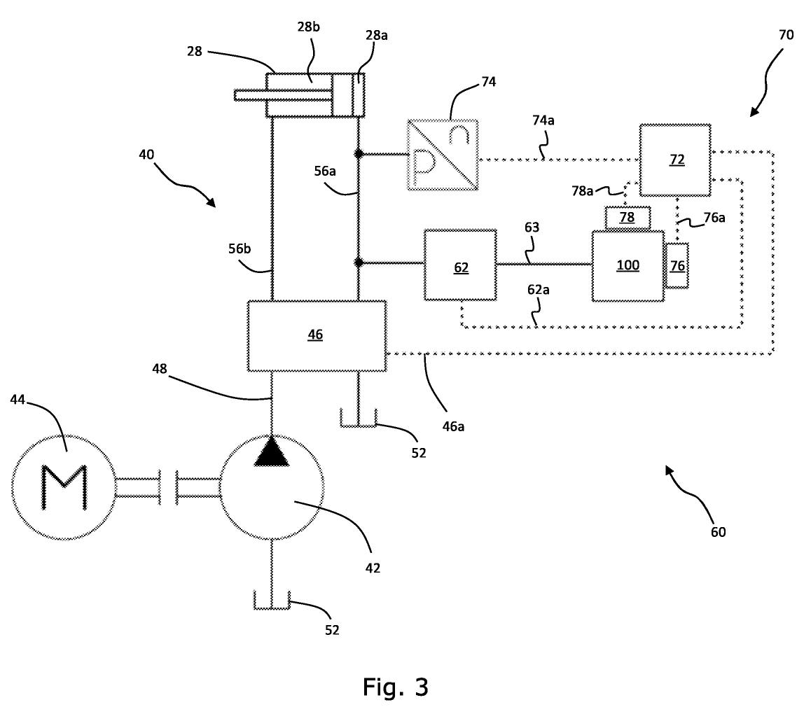

Referring now to FIG. 3, a portion of a hydraulic system for the working vehicle 10 of FIGS. 1 or 2 is illustrated. In particular,FIG. 3 illustrates a load dampening system 60 and a hydraulic circuit 40 for the load handling hydraulic actuator 28.

The load handling hydraulic actuator 28 is connected to a hydraulic pump 42 by the hydraulic circuit 40. In this way, the hydraulic pump 42 may be used to drive the load handling hydraulic actuator 28. The hydraulic pump 42 is driven by a prime mover 44 of the working vehicle 10 (e.g., an internal combustion engine or a battery-powered electric motor).

The hydraulic circuit 40 includes one or more load handling control valves 46 for directing hydraulic fluid from the hydraulic pump 42 to either: a head side chamber 28a of the load handling hydraulic actuator 28, for extending the load handling hydraulic actuator 28; or a rod side chamber 28b of the load handling hydraulic actuator 28, for retracting the load handling hydraulic actuator 28.

In the illustrated embodiment, the one or more load handling control valves 46 are electrohydraulic control valves which are controlled via a control signal 46a from a controller 72. In alternative embodiments, the one or more load handling control valves 46 may be actuated via any other suitable means. For example, the one or more load handling control valves 46 may be pilot-operated control valves operated by a pilot control system. Alternatively, the one or more load handling control valves 46 may be actuated by a control system including both pilot-operated and electrohydraulic control elements.

When the one or more load handling control valves 46 are actuated to extend or retract the load handling hydraulic actuator 28, the hydraulic pump 42 draws hydraulic fluid from a hydraulic fluid reservoir 52 and supplies said hydraulic fluid to the one or more load handling control valves 46 via a feed line 48. The one or more load handling control valves 46 then direct the hydraulic fluid from the feed line 48 either: to a head sideline 56a in communication with the head side chamber 28a of the load handling hydraulic actuator 28, for extending the load handling hydraulic actuator 28; or to a rod sideline 56b in fluid communication with the rod side chamber 28b of the load handling hydraulic actuator 28, for retracting the load handling hydraulic actuator 28. Hydraulic fluid which is expelled from the load handling hydraulic actuator 28 (e.g., from the head side chamber 28a during retraction, or from the rod side chamber 28b during extension) flows into the respective head or rod sideline 56a, 56b, through the one or more load handling control valves 46, and back to the hydraulic fluid reservoir 52.

In some embodiments, the one or more load handling control valves 46 are provided as a directional control valve (e.g., a proportional directional control valve). In other embodiments, multiple load handling control valves 46 are used (e.g., multiple proportional control valves).

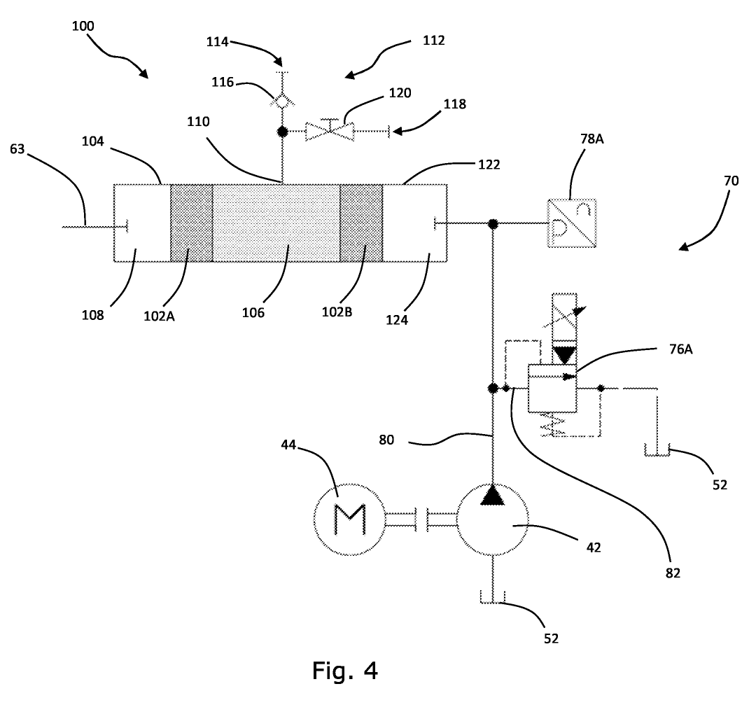

The load dampening system 60 includes an accumulator apparatus 100 for storing pressurized hydraulic fluid. Although illustrated schematically in FIG. 3, the accumulator apparatus 100 may be any of the accumulator apparatuses 100 illustrated in FIGS. 4 to 8.

The accumulator apparatus 100 is selectively connectable to the load handling hydraulic actuator 28 to act as a compliant element which dampens pressure fluctuations in the load handing hydraulic actuator 28. In particular, the accumulator apparatus 100 is connectable to the load handling actuator 28 via a load dampening valve 62.

In the illustrated embodiment, the load dampening valve 62 is provided in a load dampening line 63 which connects the accumulator apparatus 100 to the head sideline 56a described above. In this way, the accumulator apparatus 100 is configured to dampen pressure fluctuations in the head side chamber 28a, which is the load bearing chamber of the load handling hydraulic actuator 28 (i.e., the chamber which is pressurized to support a load carried by the load handling apparatus 18).

In alternative embodiments, the load handling actuator 28 may be positioned so that the rod side chamber 28b is pressurized to support a load carried by the load handling apparatus 18. In such configurations, the load dampening line 63 would be connected to the rod side chamber 28b rather than the head side chamber 28a.

In the illustrated embodiment, the load dampening valve 62 is an electrohydraulic valve which is controlled by a control signal 62a from the controller 72. For example, the controller 72 may set the control signal 62a to open the load dampening valve 62 based on: a user input (e.g., for manually turning on the load dampening function); or a detected signal (e.g., for automatically turning on the load dampening function, for example, when the working vehicle 10 is travelling above a threshold speed). In alternative embodiments, the load dampening valve 62 may be actuated via any other suitable means. For example, the load dampening valve 62 may be a pilot-operated control valve operated by a pilot control system. Alternatively, the load dampening valve 62 may be controlled both by pilot-operated and electrohydraulic control elements.

The load dampening system 60 includes a control system 70. In the illustrated embodiment, the control system 70 includes the controller 72 mentioned above. The controller 72 may be powered by a battery (not shown) and/or a generator coupled to the prime mover 44.

The control system 70 is configured to adjust a compliance of the accumulator apparatus 100 to adjust the extent to which the accumulator apparatus 100 dampens pressure fluctuations in the load handling hydraulic actuator 28. This allows the performance of the accumulator apparatus 100 to be adjusted to account for different payload masses, as well as velocity and acceleration of the working vehicle 10 and/or payload caused by travelling and/or steering of the working vehicle 10.

In some embodiments (e.g., those of FIGS. 4 to 8 described below), the control system 70 is configured for continuously variable adjustment of the compliance of the accumulator apparatus 100. For example, the accumulator apparatus 100 may include a continuously variable control member 102B, 102C, 128 (e.g., a piston, flexible diaphragm, proportional valve, etc.) and the control system 70 may be configured to move the continuously variable control member 102B, 102C, 128 to adjust the compliance of the accumulator apparatus 100. This allows the compliance of the accumulator apparatus 100 to be adjusted to any desired value between a maximum value and a minimum value, as opposed to alternative embodiments in which the accumulator apparatus 100 can only be switched between discrete compliance levels. This allows the load dampening system 60 to be tuned for a wider range of payloads and operating conditions of the working vehicle 10.

In the embodiment of FIG. 3, the control system 70 has a load sensor 74 configured to measure a mass of a payload carried by the working vehicle 10. In particular, the load sensor 74 is a pressure transducer coupled to the load handling hydraulic actuator 28. In more detail, the load sensor 74 is connected to the head sideline 56a in fluid communication with the head side chamber 28a of the load handling hydraulic actuator 28. In this way, the load sensor 74 is configured for measuring pressure in the head side chamber 28a, which is indicative of the mass of the payload carried by the working vehicle 10 (i.e., received on or in the implement 22 of the load handling apparatus 18). The load sensor 74 is configured to send a payload mass signal 74a to the controller 72.

In the illustrated embodiment, the control system 70 is configured to adjust the compliance of the accumulator apparatus 100 based on the measured payload mass. For example, the controller 72 is configured to output a control signal 76a to a compliance actuator 76 (e.g., a valve, linear actuator, or other suitable control member) for adjusting the compliance of the accumulator apparatus 100. The control signal 76a sent to the compliance actuator 76 may be based on the payload mass signal 74a received from the load sensor 74.

In some embodiments, the control system 70 may be configured to reduce compliance of the accumulator apparatus 100 as the payload mass increases. In other words, the control system 70 may be configured to increase stiffness of the accumulator apparatus 100 as the payload mass increases. Similarly, the control system 70 may be configured to increase compliance of the accumulator apparatus 100 (i.e., decrease stiffness) as the payload mass decreases. For example, the control system 70 may use an inverse relationship between payload mass and desired compliance. This avoids excessive movement of the load handling apparatus 18 of the working vehicle 10 under heavier payloads, whilst still facilitating suitable dampening for lighter payloads or unloaded operating conditions.

In alternative embodiments, the control system 70 may be configured to adjust the compliance of the accumulator apparatus 100 based on a user input rather than the measured payload mass (e.g., the load sensor 74 may be omitted). For example, the controls 26 in the cab 24 of the working vehicle may include an input, such as a dial or switch, with different compliance levels that can be manually selected by an operator (e.g., “high load mode”, “medium load mode”, “low load mode”, etc.).

In the illustrated embodiment, the control system 70 includes a compliance sensor 78 configured to measure a quantity indicative of the compliance of the accumulator apparatus 100. The controller 72 is configured to receive a compliance signal 78a from the compliance sensor 78 and to use feedback control to vary the control signal 76a sent to the compliance actuator 76. This facilitates accurate control of the compliant behavior of the load dampening system 60.

Referring now to FIG. 4, an accumulator apparatus 100 for the load dampening system 60 of FIG. 3 is illustrated.

The accumulator apparatus 100 includes a compressed fluid accumulator 104 having a compressed fluid chamber 106 for receiving compressible fluid (e.g., compressible gas), and a hydraulic fluid chamber 108 for receiving hydraulic fluid. As will be described in more detail below, the hydraulic fluid chamber 108 is for coupling to a load-bearing hydraulic circuit (e.g., the hydraulic circuit 40 of FIG. 3).

The compressed fluid accumulator 104 has a charging port 110 in fluid communication with the compressed fluid chamber 106, for input of compressible fluid to the compressed fluid chamber 106. The charging port 110 is connected to a charging circuit 112.

In the illustrated embodiment, the charging circuit 112 includes an inlet 114 for inputting compressible fluid (e.g., gas) to the compressed fluid chamber 106 to pre-charge the compressed fluid accumulator 104. The inlet 114 is coupled to the charging port 110 by a one-way valve 116. This inhibits back-flow of compressible fluid, which allows the compressible fluid to be compressed inside the compressed fluid chamber 106 at a pre-charge pressure.

The charging circuit 112 also includes an outlet 118 for releasing compressible fluid to discharge the compressed fluid accumulator 104. The outlet 118 is coupled to the charging port 110 by a drainage valve 120. The drainage valve 120 is normally shut, but may be released (e.g., manually or using a designated tool) when discharging is required. For example, the drainage valve 120 may be opened to discharge the compressible fluid in the compressed fluid chamber 106 before undertaking maintenance on the compressed fluid accumulator 104.

In the embodiment of FIG. 4, the compressed fluid accumulator 104 has a first adjustable barrier 102A at a first end of the compressed fluid chamber 106. The first adjustable barrier 102A separates the compressed fluid chamber 106 and the hydraulic fluid chamber 108.

The hydraulic fluid chamber 108 is selectively connectable to the load handling hydraulic actuator 28. In particular, the hydraulic fluid chamber 108 can be connected to the load handling hydraulic actuator 28 via the load dampening line 63 and load dampening valve 62, described above. In this way, when pressure increases in the load handling hydraulic actuator 28, this results in an increase in pressure inside the hydraulic fluid chamber 108 which can be applied via the first adjustable barrier 102A to compress the compressible fluid inside the compressed fluid chamber 106. In this way, the compressed fluid accumulator 104 provides compliance which dampens pressure fluctuations in the load handling hydraulic actuator 28.

When the accumulator apparatus 100 is used in the load dampening system 60 of FIG. 3, the control system 70 is configured to adjust a pressure in the compressed fluid chamber 106 to adjust the compliance of the accumulator apparatus 100. For example, when a stiffer response is required, pressure in the compressed fluid chamber 106 may be increased.

Similarly, when a more compliant response is required, pressure in the compressed fluid chamber 106 may be decreased.

In the embodiment of FIG. 4, the compressed fluid accumulator 104 has a second adjustable barrier 102B at a second end of the compressed fluid chamber 106. As will be described in more detail below, the control system 70 is configured to adjust the second adjustable barrier 102B in order to adjust the pressure in the compressed fluid chamber 106. In particular, the second adjustable barrier 102B is configured to be acted upon by an external force (e.g., set by the control system 70) to adjust the pressure in the compressed fluid chamber 106.

In the embodiment of FIG. 4, the first and second adjustable barriers 102A, 102B are both pistons which can slide within a cylinder housing 122 in order to transfer pressure to and from the compressed fluid in the compressed fluid chamber 106. In alternative embodiments, the first and/or second adjustable barrier 102A, 102B may comprise a flexible diaphragm. For example, adjustment of the first and/or second adjustable barrier 102A, 102B may comprise flexing of the flexible diaphragm.

In the embodiment of FIG. 4, the second adjustable barrier 102B is hydraulically actuated. In particular, the control system 70 is configured to apply pressurized hydraulic fluid to the second adjustable barrier 102B in order to adjust the second adjustable barrier 102B and thereby adjust the pressure in the compressed fluid chamber 106.

In the embodiment of FIG. 4, the compressed fluid accumulator 104 has an adjustment chamber 124 which is separated from the compressed fluid chamber 106 by the second adjustable barrier 102B. The control system 70 includes a hydraulic pump 42 connected to the adjustment chamber 124 by a hydraulic line 80. This allows hydraulic fluid to be supplied from the hydraulic pump 42 to the adjustment chamber 124 in order to apply pressurized hydraulic fluid to the second adjustable barrier 102B. The hydraulic pump 42 may be the same hydraulic pump 42 as is used to actuate the load handling hydraulic actuator 28 (as described above with reference to FIG. 3). For example, the hydraulic line 80 may branch off the feed line 48 of FIG. 3. Alternatively, the hydraulic pump 42 may be a different hydraulic pump to that used to actuate the load handling hydraulic actuator 28.

In the embodiment of FIG. 4, the control system 70 has a compliance actuator 76 in the form of an adjustable valve 76A configured to vary pressure in the hydraulic line 80. In the illustrated embodiment, the adjustable valve 76A is an electronic valve (e.g., a solenoid- operated valve). In this way, the adjustable valve 76A can be directly controlled via the control signal 76a sent from the controller 72 (as described above with reference to FIG. 3). In alternative embodiments, the adjustable valve 76A is a pilot-operated valve.

In the embodiment of FIG. 4, the adjustable valve 76A is a variable pressure relief valve connected to the hydraulic line 80 via a branch line 82. In particular, the adjustable valve 76A is a proportional pressure relief valve. The variable pressure relief valve 76A allows fluid to be transferred from the branch line 82 to the hydraulic fluid reservoir 52 when a pressure in the branch line 82 (i.e., corresponding to pressure in the adjustment chamber 124 and hydraulic line 80) is above a threshold pressure. The threshold pressure is varied in order to change the pressure in the adjustment chamber 124.

In alternative embodiments, the adjustable valve 76A may be a pressure reducing valve provided in the hydraulic line 80.

In some embodiments, the control system 70 is configured to adjust an output from the hydraulic pump 42 in order to adjust pressure in the hydraulic line 80. For example, the hydraulic pump 42 may be a variable displacement pump or a fixed displacement pump driven by a variable actuator (e.g., an electric motor). The control system 70 may increase output from the hydraulic pump 42 in order to increase pressure in the hydraulic line 80, and decrease output from the hydraulic pump 42 in order to decrease pressure in the hydraulic line 80. The control system 70 may adjust output from the hydraulic pump 42 instead of, or in addition to, actuating an adjustable valve 76A to control pressure in the hydraulic line 80.

In the embodiment of FIG. 4, the control system 70 includes a compliance sensor 78 in the form of a pressure transducer 78A configured to measure pressure in the adjustment chamber 124. This pressure in the adjustment chamber 124 is indicative of the amount of pre-charge applied to the compressible fluid in the compressed fluid chamber 106 by the second adjustable barrier 102B (which is indicative of the compliance of the accumulator apparatus 100).

In the illustrated embodiment, the pressure transducer 78A is coupled to the hydraulic line 80 in order to measure the pressure in the adjustment chamber 124.

The controller 72 is configured to receive a pressure signal 78a from the pressure transducer 78A and to use feedback control to adjust the pressure in the adjustment chamber 124 based on the pressure signal 78a. For example, the controller 72 may use feedback control to set the control signal 76a sent to the adjustable valve 76A to adjust the pressure in the adjustment chamber 124.

In the embodiment of FIG. 4, the compressed fluid accumulator 104 is provided as a single cylinder. The hydraulic fluid chamber 108, compressed fluid chamber 106, and first and second adjustable barriers 102A, 102B are provided within the single cylinder (i.e., within the cylinder housing 122).

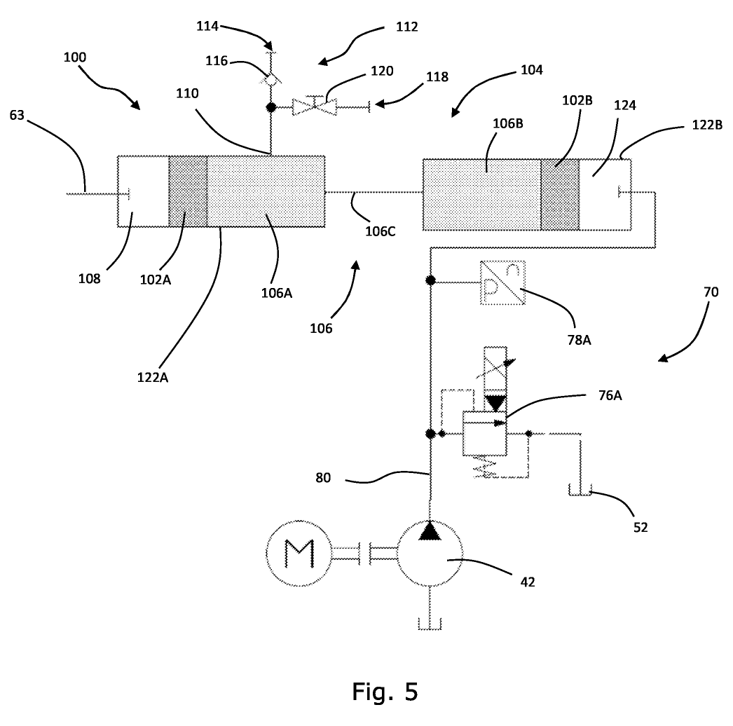

Referring now to FIG. 5, an alternative accumulator apparatus 100 for the load dampening system 60 of FIG. 3 is illustrated. The accumulator apparatus 100 of FIG. 5 is similar to that of FIG. 4. Therefore, common features are given the same reference numerals, and only differences are discussed in detail.

In the embodiment of FIG. 5, the compressed fluid accumulator 104 includes separate first and second cylinders 122A, 122B rather than a single cylinder 122 as in the previous embodiment.

The hydraulic fluid chamber 108, the first adjustable barrier 102A and a first portion 106A of the compressed fluid chamber 106 are provided within the first cylinder 122A. A second portion 106B of the compressed fluid chamber 106, the second adjustable barrier 102B and the adjustment chamber 124 are provided within the second cylinder 122B. The first and second portions 106A, 106B of the compressed fluid chamber 106 are connected to each other by a compressed fluid line 106C between the first and second cylinders 122A, 122B.

Such a compressed fluid accumulator 104 may be constructed from off-the-shelf components (e.g., two standard compressed fluid accumulators joined by the compressed fluid line 106C). This may simplify manufacturing and reduce costs in comparison to an integrated single cylinder arrangement. Further, the configuration of the compressed fluid accumulator 104 of FIG. 5 may facilitate more flexible packaging (e.g., with the first and second cylinders 122A, 122B being: coaxially aligned, parallel, at an angle to each other, one above the other, side-by-side, etc.).

In the embodiment of FIG. 5, the charging port 110 is coupled to the first portion 106A of the compressed fluid chamber 106. In some embodiments, a charging port 110 may be coupled to the second portion 106B of the compressed fluid chamber 106 (e.g., instead of or in addition to the charging port 110 coupled to the first portion 106A). In some embodiments, a charging port 110 may be coupled to the compressed fluid line 106C (e.g., instead of or in addition to a charging port 110 coupled to the first and/or second portion 106A, 106B).

Apart from the differences described above, the accumulator apparatus 100 of FIG. 5 is identical to that of FIG. 4, and is controlled by the control system 70 in the same way.

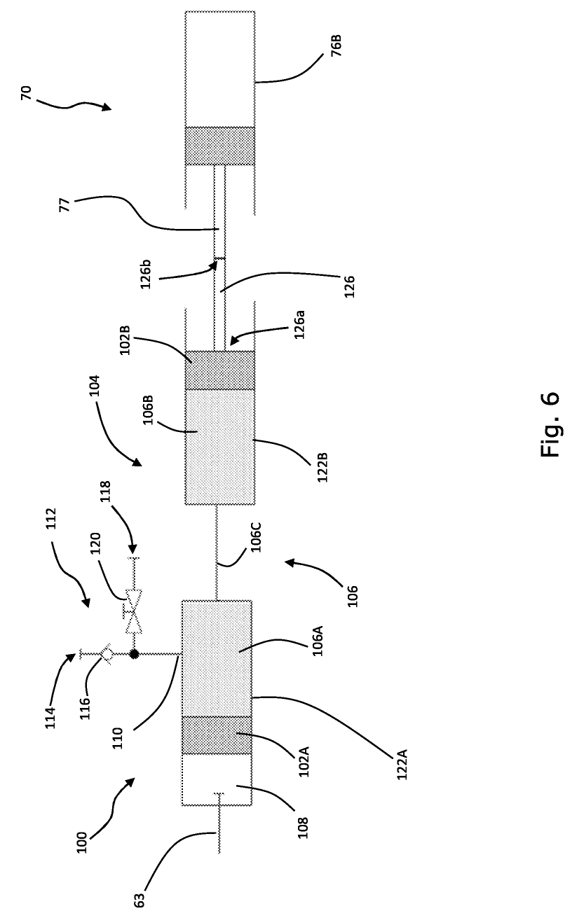

Referring now to FIG. 6, an alternative accumulator apparatus 100 for the load dampening system 60 of FIG. 3 is illustrated. Common features between the accumulator apparatus 100 of FIG. 6 and the accumulator apparatuses 100 of FIGS. 4 and 5 are given the same reference numerals, and only differences are discussed in detail.

In the embodiment of FIG. 6, the control system 70 differs from the hydraulically-actuated configuration of FIGS. 4 and 5. In particular, the control system 70 includes an adjustment actuator 76B which is mechanically coupled to the second adjustable barrier 102B (i.e., piston) for moving the second adjustable barrier 102B.

In the embodiment of FIG. 6, the accumulator apparatus 100 includes a linkage 126 (e.g., in the form of a rod) which is connected at a first end 126a to the second adjustable barrier 102B. The linkage 126 is also connected at a second end 126b to the adjustment actuator 76B for transferring movement of the adjustment actuator 76B to the second adjustable barrier 102B.

When the second adjustable barrier 102B is moved by the adjustment actuator 76B to reduce the volume of the second portion 106B of the compressed fluid chamber 106, this increases the pressure of the compressible fluid inside the compressed fluid chamber 106 (i.e., compresses the fluid). Conversely, when the second adjustable barrier 102B is moved by the adjustment actuator 76B to increase the volume of the second portion 106B of the compressed fluid chamber 106, this decreases the pressure of the compressible fluid inside the compressed fluid chamber 106. In this way, the compliance of the accumulator apparatus 100 can be adjusted via movement of the adjustment actuator 76B.

In the embodiment of FIG. 6, the adjustment actuator 76B is an electric linear actuator. In this way, the adjustment actuator 76B can be controlled via the control signal 76a sent from the controller 72 (as described above with reference to FIG. 3). In alternative embodiments, the adjustment actuator 76B is another type of actuator (e.g., a different type of electric actuator, a different type of linear actuator, or a mechanical arrangement coupled via a linkage).

In the illustrated embodiment, the adjustment actuator 76B includes an actuator rod 77 which is connected to the second end 126b of the linkage 126.

In the embodiment of FIG. 6, the compressed fluid accumulator 104 includes separate first and second cylinders 122A, 122B, in a similar way to the embodiment of FIG. 5. However, it will be understood that the compressed fluid accumulator 104 may be provided as a single cylinder 122 as in the embodiment of FIG. 4. In such an embodiment, the adjustment actuator 76B would be coupled to the second adjustable barrier 102B in a similar way to that depicted in FIG. 6.

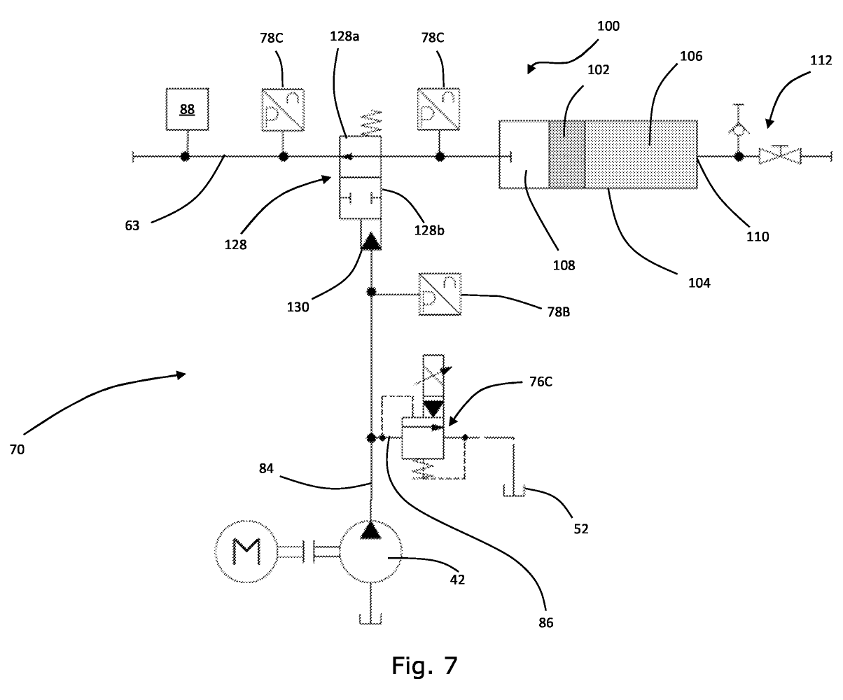

Referring now to FIG. 7, an alternative accumulator apparatus 100 for the load dampening system 60 of FIG. 3 is illustrated. Common features between the accumulator apparatus 100 of FIG. 7 and the accumulator apparatuses 100 of FIGS. 4 to 6 are given the same reference numerals, and only differences are discussed in detail.

In the embodiment of FIG. 7, the accumulator apparatus 100 includes an accumulator 104 having a hydraulic fluid chamber 108 in selective fluid communication with the load handling actuator 28. In the illustrated embodiment, the accumulator 104 is a compressed fluid accumulator having a compressed fluid chamber 106 separated from the hydraulic fluid chamber 108 by an adjustable barrier 102 (e.g., piston, flexible diaphragm, bladder, etc.). The compressed fluid chamber 106 can be pre-charged using a charging circuit 112 in a similar manner to that described above. In other embodiments, the accumulator 104 is of a different type (e.g., having a mechanically compliant element, such as a spring) instead of a compressed fluid.

The accumulator apparatus 100 of FIG. 7 has an accumulator control valve 128 provided between the hydraulic fluid chamber 108 and the load handling hydraulic actuator 28. The control system 70 is configured to vary a flow area of a restriction of the accumulator control valve 128 to adjust the compliance of the accumulator apparatus 100. In such a configuration, the variable compliance in the accumulator apparatus 100 is provided by a variable pressure drop across the variable restriction of the accumulator control valve 128, rather than by varying a direct reaction force of the accumulator 104. For example, when the flow area of the restriction of the accumulator control valve 128 is reduced, pressure drop across the accumulator control valve 128 increases, which reduces compliance.

In the embodiment of FIG. 7, the accumulator control valve 128 is a proportional control valve. For example, the flow area of the restriction of the accumulator control valve 128 may be adjusted to any desired value between a maximum flow area (e.g., a fully open state 128a) and a minimum flow area (e.g., a fully closed state 128b). This differs to alternative configurations in which the accumulator control valve 128 can only be switched between discrete states. This allows the load dampening system 60 to be tuned for a wider range of payloads and operating conditions of the working vehicle 10.

It will be understood that, because the accumulator control valve 128 can be fully closed (i.e., in the closed state 128b) to block flow along the load dampening line 63, the load dampening valve 62 illustrated in FIG. 3 may be omitted when using the accumulator apparatus 100 of FIG. 7. Alternatively, the load dampening valve 62 may be retained as an on/off switch for enabling the load dampening system 60.

In the embodiment of FIG. 7, the accumulator control valve 128 is a pilot-operated valve having a pilot port 130. The control system 70 includes a hydraulic pump 42 connected to the pilot port 130 by a pilot line 84. In this way, pressurized hydraulic fluid can be applied to the pilot port 130 to adjust the restriction of the accumulator control valve 128. In the illustrated embodiment, the accumulator control valve 128 is biased towards the fully open state 128a (e.g., by a spring). As the pressure, which is applied to the pilot port 130 increases, the accumulator control valve 128 moves towards the closed state 128b, through a continuous range of partially open states.

In alternative embodiments, the accumulator control valve 128 may be biased towards the fully closed state 128b (e.g., by a spring). In such embodiments, as the pressure, which is applied to the pilot port 130 increases, the accumulator control valve 128 moves towards the open state 128a, through a continuous range of partially open states.

The hydraulic pump 42 used to pressure the pilot line 84 may be the same hydraulic pump 42 as is used to actuate the load handling hydraulic actuator 28 (as described above with reference to FIG. 3). For example, the pilot line 84 may branch off the feed line 48 illustrated in FIG. 3. Alternatively, the hydraulic pump 42 may be a different hydraulic pump to that used to actuate the load handling hydraulic actuator 28.

The control system 70 of FIG. 7 includes a compliance actuator 76 in the form of an adjustable valve 76C configured to vary pressure in the pilot line 84. In the illustrated embodiment, the adjustable valve 76C is an electronic valve (e.g., a solenoid-operated valve). In this way, the adjustable valve 76C can be directly controlled via the control signal 76a sent from the controller 72 (as described above with reference to FIG. 3). In alternative embodiments, the adjustable valve 76C is a pilot-operated valve.

In the embodiment of FIG. 7, the adjustable valve 76C is a variable pressure relief valve connected to the pilot line 84 via a branch line 86. In particular, the adjustable valve 76C is a proportional pressure relief valve. The variable pressure relief valve 76C allows fluid to be transferred from the branch line 86 to the hydraulic fluid reservoir 52 when a pressure in the branch line 86 (i.e., at the pilot port 130 and in the pilot line 84) is above a threshold pressure. The threshold pressure is varied in order to change the pressure in at the pilot port 130.

In alternative embodiments, the adjustable valve 76C may be a pressure reducing valve provided in the pilot line 84.

In some embodiments, the control system 70 is configured to adjust an output from the hydraulic pump 42 in order to adjust pressure in the pilot line 84. For example, the hydraulic pump 42 may be a variable displacement pump or a fixed displacement pump driven by a variable actuator (e.g., an electric motor). The control system 70 may increase output from the hydraulic pump 42 in order to increase pressure in the pilot line 84, and decrease output from the hydraulic pump 42 in order to decrease pressure in the pilot line 84. The control system 70 may adjust output from the hydraulic pump 42 instead of, or in addition to, actuating an adjustable valve 76C to control pressure in the pilot line 84.

In the embodiment of FIG. 7, the control system 70 includes a compliance sensor 78 in the form of a pressure transducer 78B configured to measure pressure in the pilot line 84. This pressure in the pilot line 84 is indicative of the flow area of the variable restriction of the accumulator control valve 128 (which is indicative of pressure drop across the accumulator control valve and thus the compliance of the accumulator apparatus 100).

The controller 72 is configured to receive a pressure signal 78a from the pressure transducer 78B and to use feedback control to adjust the pressure in the pilot line 84 based on the pressure signal 78a. For example, the controller 72 may use feedback control to set the control signal 76a sent to the adjustable valve 76C to adjust the pressure in the pilot line 84.

In alternative embodiments, the accumulator control valve 128 is an electronic valve. For example, the accumulator control valve 128 may include a compliance actuator 76 in the form of a solenoid which is configured to receive the control signal 76a from the controller 72 to adjust the flow area of the variable restriction.

In the embodiment of FIG. 7, the control system 70 includes a pair of pressure transducers 78C configured to measure pressure drop across the restriction of the accumulator control valve 128. In particular, there is a first pressure transducer 78C provided on a first side of the accumulator control valve 128, between the accumulator control valve 128 and the hydraulic fluid chamber 108. A second pressure transducer 78C is provided in the load dampening line 63 on an opposite side of the accumulator control valve 128. Alternatively, the pressure transducer 74 illustrated in FIG. 3 may be used as the second pressure transducer.

The controller 72 is configured to receive pressure signals from the pair of pressure transducers 78C, and to use feedback control to adjust the restriction of the accumulator control valve 128 based on the first and second pressure signals (e.g., to attain a desired pressure drop to achieve a desired compliant behavior of the load dampening system 60).

In some embodiments, the control system 70 includes a temperature sensor 88 configured to measure a temperature of hydraulic fluid in the load handling actuator 28, the hydraulic fluid chamber 108 and/or the load dampening line 63 therebetween. For example, in FIG. 7 a temperature sensor 88 is provided to measure temperature of hydraulic fluid in the load dampening line 63.

The controller 72 is configured to receive a temperature signal from the temperature sensor 88 and to adjust the compliance of the accumulator apparatus 100 based on the temperature signal (e.g., by adjusting the restriction of the accumulator control valve 128 in the configuration of FIG. 7). For example, the controller 72 may have a memory containing a stored temperature-to-viscosity relationship (e.g., a model) for the hydraulic fluid. The controller 72 may be configured to use the stored temperature-to-viscosity relationship and the temperature signal from the temperature sensor 88 to determine a viscosity of the hydraulic fluid in the load dampening line 63. The controller 72 may be further configured to adjust the compliance of the accumulator apparatus 100 based on the determined viscosity (e.g., by adjusting the restriction of the accumulator control valve 128 in the configuration of FIG. 7). This facilitates tuning of the accumulator apparatus 100 to account for variations in viscosity of the hydraulic fluid.

It will be understood that the controller 72 may incorporate signals from more than one of the pressure transducers 78B, 78C and the temperature sensor 88 (e.g., all of them) in order to adjust the compliance of the accumulator apparatus to achieve the desired compliant behavior (e.g., by setting the control signal 76a sent to the variable pressure relief valve 76C in the configuration of FIG. 7). For example, the controller 72 may be configured to implement multi-input feedback control to achieve the desired compliant behavior.

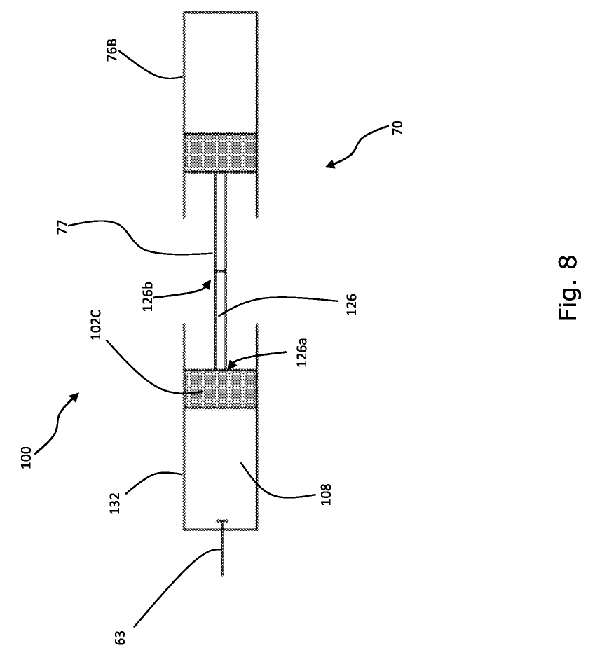

Referring now to FIG. 8, an alternative accumulator apparatus 100 for the load dampening system 60 of FIG. 3 is illustrated. Common features between the accumulator apparatus 100 of FIG. 8 and the accumulator apparatuses 100 of FIGS. 4 to 7 are given the same reference numerals, and only differences are discussed in detail.

In the embodiment of FIG. 8, the accumulator apparatus 100 includes a hydraulic cylinder 132 having a hydraulic fluid chamber 108 in selective fluid communication with the load handling actuator 28 (e.g., via the load dampening line 63). The hydraulic cylinder 132 includes an adjustable barrier 102C (e.g., a piston) for varying the volume of the hydraulic fluid chamber 108.

The control system 70 is configured to use feedback control to directly adjust the adjustable barrier 102C in response to changes in pressure in the hydraulic fluid chamber 108. In other words, instead of a compressed fluid (e.g., gas) or another energy storage mechanism (e.g., a spring) being used to act as a compliant spring element, the control system 70 uses feedback control to directly move the adjustable barrier 102C to mimic the behavior of a spring element. Put another way, the control system 70 directly moves the adjustable barrier 102C so that it behaves in a similar manner to the way in which a corresponding adjustable barrier (e.g., piston or flexible diaphragm) would be urged by a spring element (e.g., in a compressed fluid accumulator configuration). In other words, the configuration of FIG. 8 can still be considered an “accumulator apparatus” because it provides a similar response to an accumulator, despite this being achieved by active actuation rather than passive energy storage in a spring element or compressed fluid.

As an example, as pressure rises in the hydraulic fluid chamber 108, the control system 70 may move the adjustable barrier 102C to increase the volume in the hydraulic fluid chamber 108, which dampens the pressure increase accordingly. This mimics the compliant response of a normal accumulator (e.g., a compressed fluid accumulator). After a period of time, the control system 70 may return the adjustable barrier 102C to decrease the volume in the hydraulic fluid chamber 108. This mimics the resilient response of a normal accumulator (e.g., a compressed fluid accumulator).

The controller 72 of the control system 70 may use a dynamic model to set the compliant and resilient response characteristics of the accumulator apparatus 100. One or more parameters of the dynamic model may be adjusted in order to adjust the compliance of the accumulator apparatus 100 to adjust the extent to which the accumulator apparatus 100 dampens pressure fluctuations in the load handling hydraulic actuator 28.

In order to detect changes in pressure in the hydraulic fluid chamber 108 (i.e., as an input to the feedback control algorithm), the pressure signal 74a sent from the pressure transducer 74 (illustrated in FIG. 3) may be used. Alternatively, an additional pressure sensor or transducer may be provided closer to the hydraulic fluid chamber 108 (e.g., in the load dampening line 63). It will be understood that, when the load dampening valve 62 is open, the pressure fluctuations in the hydraulic fluid chamber 108 will correspond approximately to the pressure fluctuations in the load handling hydraulic actuator 28.

In the embodiment of FIG. 8, the control system 70 includes a compliance actuator 76 in the form of an adjustment actuator 76B which is mechanically coupled to the adjustable barrier 102C (e.g., piston) for directly moving the adjustable barrier 102C. In the illustrated embodiment, the adjustment actuator 76B is an electric linear actuator (e.g., of a similar kind to that used in the embodiment of FIG. 6). In this way, the adjustment actuator 76B can be directly controlled via the control signal 76a sent from the controller 72 (as described above with reference to FIG. 3). In alternative embodiments, the adjustment actuator 76B is another type of actuator (e.g., a different type of electric actuator or a different type of linear actuator).

In alternative embodiments, the hydraulic cylinder 132 may include an adjustment chamber separated from the hydraulic fluid chamber 108 by the adjustable barrier 102 (e.g., piston). In such embodiments, the control system may be configured to supply pressurized fluid to the adjustment chamber to move the adjustable barrier 102 (e.g., piston). For example, a hydraulic circuit similar to that illustrated in FIGS. 4, 5 and 7 may be used to supply such a pressurized hydraulic fluid. In such embodiments, the controller 72 may send a control signal 76a to an adjustable valve in order to move the adjustable barrier 102.

In some embodiments, the load dampening system 60 includes first and second accumulator apparatuses 100 which are each selectively connectable to the load handling hydraulic actuator 28 to act as a compliant element which dampens pressure fluctuations in the load handing hydraulic actuator. For example, the first and second accumulator apparatuses 100 may be any of the accumulator apparatuses of FIGS. 4 to 8, described above.

In such embodiments, the control system may be configured to adjust the compliance of the first accumulator apparatus 100 between a first range of compliance values, and to adjust the compliance of the second accumulator apparatus 100 between a second range of compliance values, different to the first range of compliance values. This facilitates a wider range of compliance values than may be possible with a single accumulator apparatus 100. For example, where the first and second accumulator apparatuses 100 include compressed fluid accumulators 104, the first compressed fluid accumulator 104 may be pre-charged to a higher pressure than the second compressed fluid accumulator 104.

The control system 70 may select the most suitable of the accumulator apparatuses 100 to use for a given payload or operating condition (e.g., the first accumulator apparatus 100 may be selected for loaded conditions and the second accumulator apparatus 100 may be selected for unloaded conditions). The control system 70 may subsequently tune the compliance of the selected accumulator apparatus based on other factors such as payload mass, and velocity/acceleration of the payload and/or working vehicle 10.

The controller 72 mentioned above may comprise: control circuitry; and/or processor circuitry; and/or at least one application specific integrated circuit (ASIC); and/or at least one field programmable gate array (FPGA); and/or single or multi-processor architectures; and/or sequential/parallel architectures; and/or at least one programmable logic controllers (PLCs); and/or at least one microprocessor; and/or at least one microcontroller; and/or a central processing unit (CPU), to perform the described methods. The controller 72 may include an associated memory or the memory may be located locally to the controller 72 or remotely. The memory may be a non-volatile flash memory.

It will be understood that the schematic diagrams of FIGS. 3 to 8 are simplified diagrams, but that the hydraulic circuits shown therein may include various other components such as flow restrictors, valves, filters, additional pumps, additional actuators, pilot control components, electrohydraulic control components, further hydraulic fluid lines, etc., to facilitate control of hydraulic fluid. Similarly, the skilled person would understand that the electric actuators shown therein will receive electrical power (e.g., via the controller 72) from a suitable electrical source (e.g., a battery or generator).

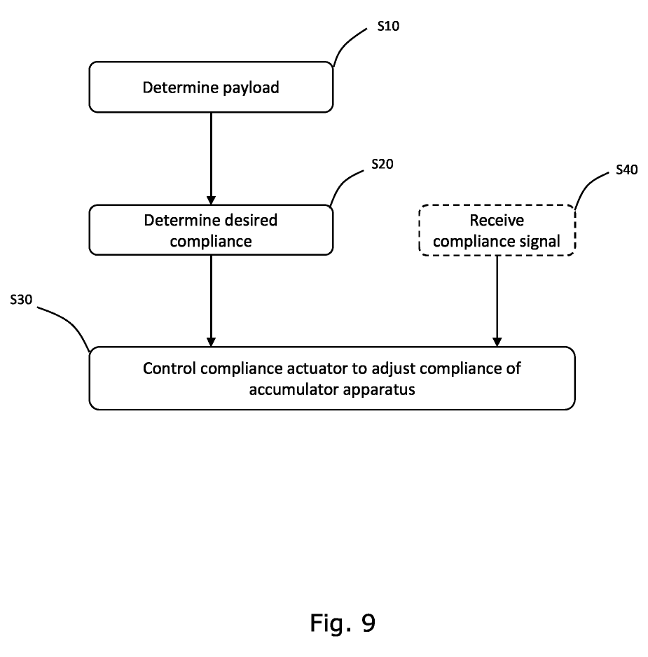

Referring now to FIG. 9, a method of adjusting compliance in an accumulator apparatus 100 is illustrated as a flow chart. The method comprises the following steps: determining a payload supported by a load handling actuator 28 of a working vehicle (at step S10); using the determined payload to determine a desired compliance of an accumulator apparatus 100 which is connected to the load handling actuator 28 (at step S20); and controlling a compliance actuator 76 in order to adjust the compliance of the accumulator apparatus 100 as desired (at step S30).

In some embodiments, step S10 may include receiving a payload mass signal 74a from a load sensor 74, the payload mass signal 74a being indicative of a payload supported by a load handling actuator 28.

In some embodiments, step S30 may include determining a control signal 76a required to achieve the desired compliance of the accumulator apparatus 100, and outputting the determined control signal 76a to the compliance actuator 76.

In the illustrated embodiment, the method includes the optional step of receiving a compliance signal 78a from a compliance sensor 78 (at step S40). Such a compliance signal 78a may be indicative of the compliance of the accumulator apparatus 100 and may be used at step S30 to determine how to control the compliance actuator 76 (e.g., using feedback control).

In some embodiments, step S20 involves reducing the desired compliance as the determined payload mass increases. In other words, step S20 involves increasing the desired compliance as the determined payload mass decreases. In other words, the method may use an inverse relationship between payload mass and desired compliance.

The one or more embodiments are described above by way of example only and it will be appreciated that the variations are possible without departing from the scope of protection afforded by the appended claims.

It should also be noted that whilst the appended claims set out particular combinations of features described above, the scope of the present disclosure is not limited to the particular combinations hereafter claimed, but instead extends to encompass any combination of features herein disclosed.

1. A load dampening system for a working vehicle, the load dampening system comprising:
a load handling hydraulic actuator configured to support a load carried by the working vehicle;
an accumulator apparatus for storing pressurized hydraulic fluid, wherein the accumulator apparatus is selectively connectable to the load handling hydraulic actuator to act as a compliant element which dampens pressure fluctuations in the load handing hydraulic actuator; and
a control system configured to adjust a compliance of the accumulator apparatus to adjust the extent to which the accumulator apparatus dampens pressure fluctuations in the load handling hydraulic actuator.

2. The load dampening system of claim 1, wherein the control system is configured for continuously variable adjustment of the compliance of the accumulator apparatus; optionally, wherein the accumulator apparatus comprises a continuously variable control member and wherein the control system is configured to move the continuously variable control member to adjust the compliance of the accumulator apparatus.

3. The load dampening system of claim 1, wherein the control system comprises a load sensor configured to measure a mass of a payload carried by the working vehicle, wherein the control system is configured to adjust the compliance of the accumulator apparatus based on the measured payload mass; optionally, wherein the load sensor comprises a pressure sensor or transducer coupled to the load handling hydraulic actuator; optionally, wherein the control system is configured to reduce compliance of the accumulator apparatus as the payload mass increases; and/or optionally, wherein the control system comprises a controller configured to receive a payload mass signal from the load sensor and output a control signal to a compliance actuator for adjusting the compliance of the accumulator apparatus, optionally, wherein the control system comprises a compliance sensor configured to measure a quantity indicative of the compliance of the accumulator apparatus, wherein the controller is configured to receive a compliance signal from the compliance sensor and to use feedback control to vary the control signal.

4. The load dampening system of claim 1, wherein the accumulator apparatus comprises a compressed fluid accumulator having a compressed fluid chamber and a hydraulic fluid chamber which is selectively connectable to the load handling hydraulic actuator, and wherein the control system is configured to adjust a pressure in the compressed fluid chamber to adjust the compliance of the accumulator apparatus.

5. The load dampening system of claim 4, wherein the compressed fluid accumulator comprises a first adjustable barrier at a first end of the compressed fluid chamber, the first adjustable barrier separating the compressed fluid chamber and the hydraulic fluid chamber, wherein the compressed fluid accumulator further comprises a second adjustable barrier at a second end of the compressed fluid chamber, wherein the control system is configured to adjust the second adjustable barrier in order to adjust the pressure in the compressed fluid chamber; optionally, wherein the first and/or second adjustable barrier comprises a piston.

6. The load dampening system of claim 5, wherein the compressed fluid accumulator comprises a single cylinder, and wherein the hydraulic fluid chamber, compressed fluid chamber and first and second adjustable barriers are provided within the single cylinder.

7. The load dampening system of claim 5, wherein the compressed fluid accumulator comprises a first cylinder and a second cylinder, wherein the hydraulic fluid chamber, first adjustable barrier and a first portion of the compressed fluid chamber are provided within the first cylinder, wherein a second portion of the compressed fluid chamber and the second adjustable barrier are provided within the second cylinder, and wherein the first and second portions of the compressed fluid chamber are connected to each other by a compressed fluid line between the first and second cylinders.

8. The load dampening system of claim 5, wherein the control system is configured to apply pressurized hydraulic fluid to the second adjustable barrier in order to adjust the second adjustable barrier and thereby adjust the pressure in the compressed fluid chamber.

9. The load dampening system of claim 8, wherein the compressed fluid accumulator comprises an adjustment chamber, wherein the second adjustable barrier separates the compressed fluid chamber from the adjustment chamber, and wherein the control system comprises a hydraulic pump connected to the adjustment chamber by a hydraulic line in order to apply pressurized hydraulic fluid to the second adjustable barrier; optionally, wherein the control system comprises an adjustable valve configured to vary pressure in the hydraulic line; optionally, wherein the adjustable valve is an electronic valve, optionally a solenoid-operated valve, optionally, wherein the adjustable valve comprises a variable pressure relief valve connected to the hydraulic line via a branch line, optionally a proportional pressure relief valve, and/or optionally, wherein the adjustable valve comprises a pressure reducing valve provided in the hydraulic line; and/or optionally, wherein the control system is configured to adjust an output from the hydraulic pump in order adjust pressure in the hydraulic line; and/or optionally, wherein the control system comprises a pressure sensor or transducer configured to measure pressure in the adjustment chamber, and a controller configured to receive a pressure signal from the pressure sensor or transducer and to use feedback control to adjust the pressure in the adjustment chamber based on the pressure signal.

10. The load dampening system of claim 5, wherein the second adjustable barrier comprises a piston and wherein the control system comprises an adjustment actuator which is mechanically coupled to the piston for moving the piston; optionally, wherein the adjustment actuator comprises a linear actuator; optionally, an electric linear actuator.

11. The load dampening system of claim 1, wherein the accumulator apparatus comprises an accumulator having a hydraulic fluid chamber in selective fluid communication with the load handling actuator, and an accumulator control valve provided between the hydraulic fluid chamber and the load handling hydraulic actuator, wherein the control system is configured to vary a flow area of a restriction of the accumulator control valve to adjust the compliance of the accumulator apparatus; optionally, wherein the accumulator control valve is a proportional control valve.

12. The load dampening system of claim 11, wherein the accumulator control valve is an electronic valve, optionally a solenoid-operated valve.

13. The load dampening system of claim 11, wherein the accumulator control valve is a pilot-operated valve having a pilot port, and wherein the control system comprises a hydraulic pump connected to the pilot port by a pilot line in order to apply pressurized hydraulic fluid to the pilot port to adjust the restriction of the accumulator control valve; optionally, wherein the control system comprises an adjustable valve configured to vary pressure in the pilot line; optionally, wherein the adjustable valve is an electronic valve, optionally a solenoid-operated valve, optionally, wherein the adjustable valve comprises a variable pressure relief valve connected to the pilot line via a branch line, optionally a proportional pressure relief valve; and/or wherein the adjustable valve comprises a pressure reducing valve provided in the pilot line; and/or optionally, wherein the control system is configured to adjust output from the hydraulic pump in order adjust pressure in the pilot line; and/or optionally, wherein the control system comprises a pressure sensor or transducer configured to measure pressure in the pilot line, and a controller configured to receive a pressure signal from the pressure sensor or transducer and to use feedback control to adjust the pressure in the pilot line based on the pressure signal.

14. The load dampening system of claim 11, wherein the control system comprises first and second pressure sensors or transducers configured to measure pressure drop across the restriction of the accumulator control valve, and a controller configured to receive first and second pressure signals from the first and second pressure sensors or transducers and to use feedback control to adjust the flow area of the restriction of the accumulator control valve based on the first and second pressure signals.

15. The load dampening system of claim 11, wherein the control system comprises a temperature sensor configured to measure a temperature of hydraulic fluid in the load handling actuator, the hydraulic fluid chamber and/or a hydraulic line therebetween, and a controller configured to receive a temperature signal from the temperature sensor and to adjust the restriction of the accumulator control valve based on the temperature signal; optionally, wherein the controller comprises a memory having a stored temperature-to-viscosity relationship for the hydraulic fluid, wherein the controller is configured to use the stored temperature-to-viscosity relationship and the temperature signal to determine a viscosity of the hydraulic fluid, and wherein the controller is further configured to adjust the restriction of the accumulator control valve based on the determined viscosity.

16. The load dampening system of claim 1, wherein the accumulator apparatus comprises a hydraulic cylinder having a hydraulic fluid chamber in selective fluid communication with the load handling actuator, and an adjustable barrier for varying the volume of the hydraulic fluid chamber, wherein the control system is configured to use feedback control to directly adjust the adjustable barrier in response to changes in pressure in the hydraulic fluid chamber; optionally, wherein the adjustable barrier comprises a piston; optionally, wherein the control system comprises an electric actuator configured to move the piston, or wherein the hydraulic cylinder comprises an adjustment chamber separated from the hydraulic fluid chamber by the piston, and wherein the control system is configured to supply pressurized fluid to the adjustment chamber to move the piston.

17. The load dampening system of claim 1, wherein the accumulator apparatus comprises first and second accumulator apparatuses which are each selectively connectable to the load handling hydraulic actuator to act as a compliant element which dampens pressure fluctuations in the load handing hydraulic actuator, wherein the control system is configured to adjust the compliance of the first accumulator apparatus between a first range of compliance values, and to adjust the compliance of the second accumulator apparatus between a second range of compliance values, different to the first range of compliance values.

18. A working vehicle comprising the load dampening system of claim 1, and a load handling apparatus configured to be moved by the load handling hydraulic actuator; optionally, wherein the working vehicle comprises a hydraulic pump connected to the load handling hydraulic actuator by a hydraulic circuit, for actuating the load handling apparatus; optionally, wherein the working vehicle comprises a telescopic handler, a wheel loading shovel, a backhoe loader, or another type of vehicle having a loader arm.

19. An adjustable compressed fluid accumulator comprising:
a compressed fluid chamber,
a hydraulic fluid chamber for coupling to a load-bearing hydraulic circuit,
a first adjustable barrier at a first end of the compressed fluid chamber, the first adjustable barrier separating the compressed fluid chamber and the hydraulic fluid chamber, and
a second adjustable barrier at a second end of the compressed fluid chamber, the second adjustable barrier being configured to be acted upon by an external force to adjust the pressure in the compressed fluid chamber.

20. A method of adjusting compliance in an accumulator apparatus, the method comprising:
a) determining a payload mass supported by a load handling actuator of a working vehicle;
b) using the determined payload mass to determine a desired compliance of an accumulator apparatus which is connected to the load handling actuator; and
c) controlling a compliance actuator in order to adjust the compliance of the accumulator apparatus as desired;
optionally, wherein step a) comprises receiving a payload mass signal from a load sensor, the payload mass signal being indicative of a payload supported by a load handling actuator; and/or
optionally, wherein step c) comprises determining a control signal required to achieve the desired compliance of the accumulator apparatus, and outputting the determined control signal to the compliance actuator; and/or
optionally, wherein the method comprises receiving a compliance signal indicative of the compliance of the accumulator apparatus from a compliance sensor, and using the compliance signal at step c) to determine how to control the compliance actuator (e.g., using feedback control); and/or
optionally, wherein step b) comprises reducing the desired compliance as the determined payload mass increases.
